(19) United States
(12) Patent Application Publication
(10) Pub. No.: US 2010/0180452 A1
(43) Pub. Date: Jul. 22, 2010

(54) Clean edge food cutting utensil

(76) Inventor: Joshua Carmine Mucci, San Francisco, CA (US)

Correspondence Address: Clint Mehall, # PHB, 491 Columbus Ave., New York, NY, 10024, US

(21) Appl. No.: 12/321,252

(22) Filed: Jan. 20, 2009

(51) Int. Cl. B26B 3/00; B26B 9/02

(52) U.S. Cl. 30/314; 30/356; 426/518

(57) ABSTRACT

A cutting utensil for cutting food items resting on a cutting surface is provided. The cutting utensil includes a cutting blade including a blade cutting edge having a longitudinal axis. The cutting blade includes a plurality of offset portions that are offset from the longitudinal axis. The cutting blade further includes an edge tip for contacting the food item. The edge tip is adapted to allow cutting blade to be rocked back and forth about the blade cutting edge. A handle is connected to the cutting blade that is capable of be gripped by a user and used to rock the cutting blade back and forth about the blade cutting edge on the cutting surface. A method of cutting a food item positioned on a cutting surface is also provided.

### BACKGROUND OF THE INVENTION

Sandwiches and most other food items, particularly hand eaten food items, have traditionally been cut with straight edge blades, such as conventional knives, leaving the severed portions of foods items with straight edges. These straight edges can cause a person eating the food item to get a different amount of food in each bite and may make it difficult for the person to get a bite a large as desired. Additionally, food items cut with straight edge blades may have ingredients dispersed within the food item such that the person eating the food item does not get a desired ratio of ingredients in each bite.

### BRIEF SUMMARY OF THE INVENTION

A cutting utensil for cutting food items resting on a cutting surface is provided. The cutting utensil includes a cutting blade including a blade cutting edge having a longitudinal axis. The cutting blade includes a plurality of offset portions that are offset from the longitudinal axis. The cutting blade further includes an edge tip for contacting the food item. The edge tip is adapted to allow cutting blade to be rocked back and forth about the blade cutting edge. A handle is connected to the cutting blade that is capable of be gripped by a user and used to rock the cutting blade back and forth about the blade cutting edge on the cutting surface.

A method of cutting a food item positioned on a cutting surface is also provided. The method includes the steps of providing a cutting blade including a blade cutting edge, the blade cutting edge traversing a longitudinal axis of the blade cutting edge to form offset portions, the blade cutting edge including an edge tip near or on a longitudinal center of the blade cutting edge; placing a food item on the cutting surface; contacting the food item with the blade cutting edge; and rocking the cutting blade back and forth about the blade cutting edge to cut the food item.

### BRIEF DESCRIPTION OF THE DRAWINGS

The present invention is described below by reference to the following drawings, in which:

FIG. 1 schematic plan view of a blade cutting edge of a clean edge cutting utensil according to an embodiment of the present invention;

FIG. 2 shows a schematic front view of a clean edge cutting utensil according to an embodiment of the present invention having the blade cutting edge shown in FIG. 1;

FIG. 3 shows a schematic perspective view of a cutting blade of the clean edge cutting utensil shown in FIG. 2;

FIG. 4 shows a schematic side view of the clean edge cutting utensil shown in FIG. 2;

FIG. 5a shows a schematic top view of a sandwich cut by the clean edge cutting utensil shown in FIG. 2;

FIG. 5b shows a schematic top view of a sandwich cut by the clean edge cutting utensil shown in FIG. 9a;

FIG. 6 shows a schematic side view of a clean edge cutting utensil according to another embodiment of the present invention;

FIG. 7 shows a schematic front view of a clean edge cutting utensil according to another embodiment of the present invention;

FIG. 8 shows bottom view of the clean edge cutting utensil shown in FIG. 7; and

FIGS. 9a to 9g show various blade cutting edges according to further embodiments of the present invention.

### DETAILED DESCRIPTION OF THE DRAWINGS

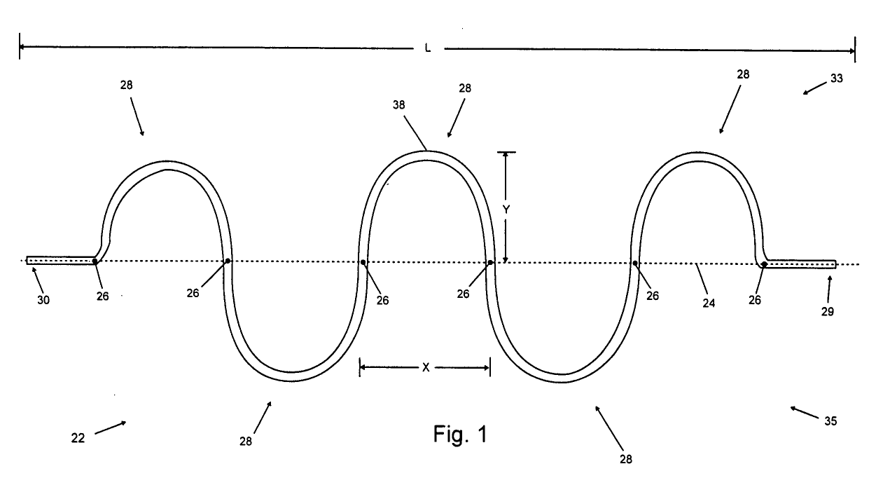

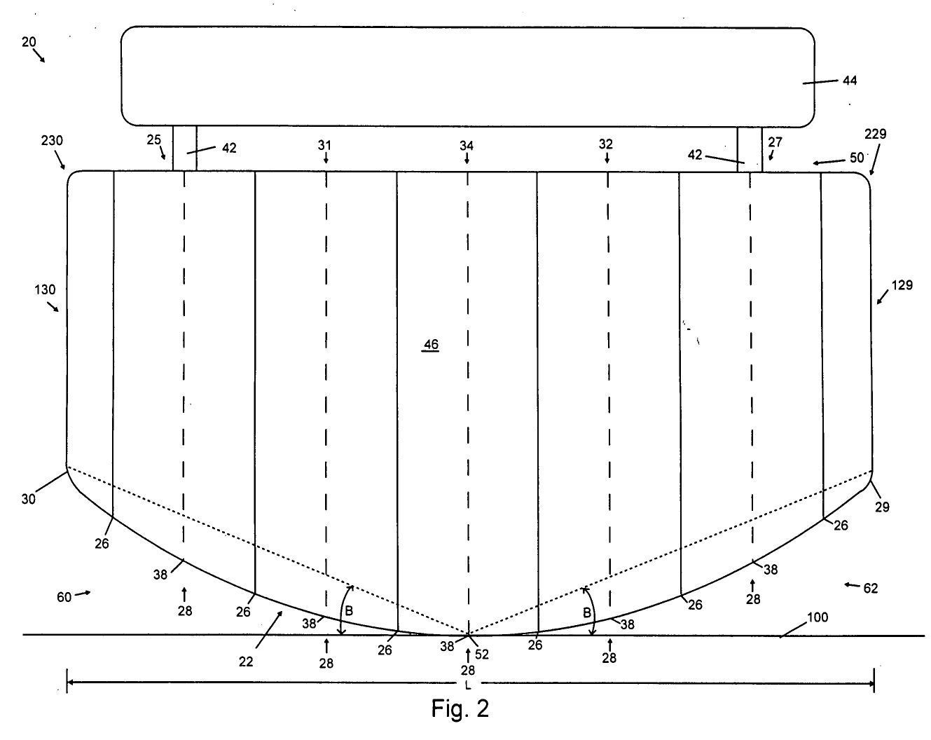

FIG. 1 shows bottom plan view of a blade cutting edge 22 of a cutting blade 40 (FIG. 2) of clean edge cutting utensil 20 (FIG. 2) according to an embodiment of the present invention. Blade cutting edge 22 does not follow a longitudinal axis 24 of blade cutting edge 22, as does a conventional knife, but traverses longitudinal axis 24 at one or more longitudinal center points 26. Between center points 26, longitudinal offset portions 28 of blade cutting edge 22 define a variable path of blade cutting edge 22. In this embodiment, blade cutting edge 22 includes five offset portions 28, three on a first side 33 of cutting edge 22 and two on a second side 35 of cutting edge 22, which give cutting edge 22 a wave shape, with every other offset portion 28 being on an opposite side of longitudinal axis 24. Each offset portion 28 includes a peak 38, which is a point on each offset portion 28 that is a greatest distance from longitudinal axis 24. In this embodiment, peaks 38 are near the center of each offset portion 28, but in other embodiments, peaks 38 may be off-centered with respect to the respective offset portion 28. Blade cutting edge 22 forms a continuous path between cutting edge ends 29, 30. Cutting edge ends 29, 30 may be close to or on longitudinal axis 24 for cutting stability.

In this embodiment, each offset portion 28 follows a rounded path at each respective peak 38 and cutting edge 22 follows an oscillatory path between center points 26 such that offset portions 28 follow path shape approximately like a semi-oval between center points 26. Center points may be separated by a distance X and peaks 38 may be a distance Y away from longitudinal axis 24. In preferred embodiments of the present invention, distance X is between 0.6 and 1.5 inches and distance Y is between 0.4 and 0.7 inches. Center points 26 may also be separated by different distances so that one or offset portions 28 are of different lengths from one another.

In alternative embodiments, peaks 38 may be closer and further away from longitudinal axis depending on the desired variability of a bite edge of the food item. Longitudinal length L of cutting edge 22 may also be varied to increase or decrease the cutting length of cutting edge 22. A longitudinally shorter cutting edge 22 may be desirable for cutting stability as a shorter cutting edge 22 may give a user of the cutting utensil 20 more control and may prevent unwanted lateral movement during rocking of the cutting utensil 20 (FIG. 2). A longer cutting edge may be desirable for cutting larger food items, such as pizzas or quesadillas.

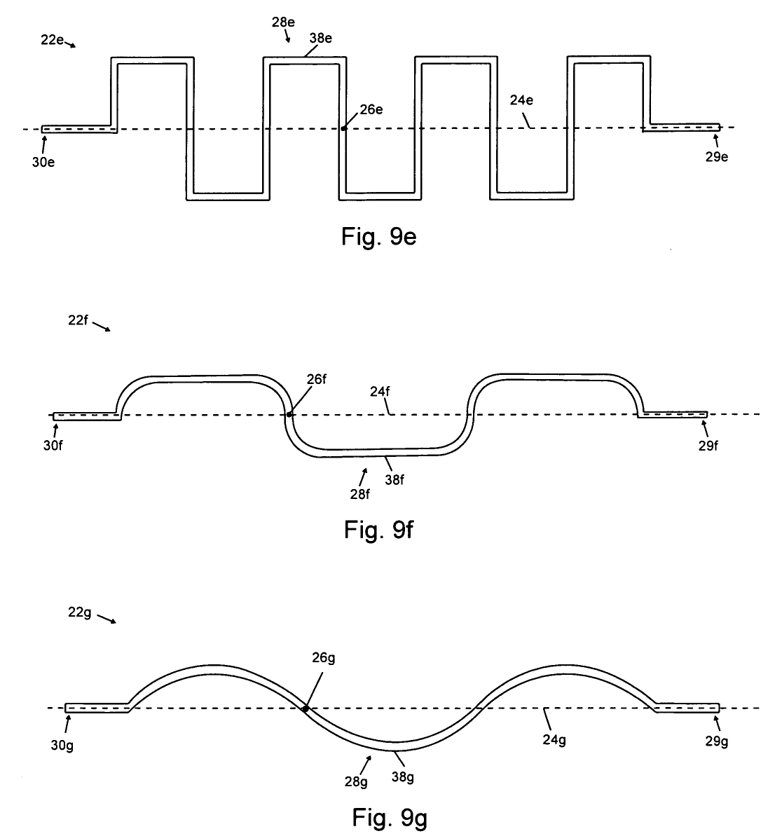

In alternative embodiments of the present invention, blade cutting edge 22 may include more or less than five offset portions. Also, the path that cutting edge 22 follows between center points 26 and peaks 38 may vary. Cutting edge 22 may follow an oscillatory path and may follow a curved path between center points 26 and peaks 38, as shown for example in FIG. 1. Cutting edge 22 may also follow a direct path between center points 26 and peaks 38, as shown for example in FIG. 9a, with offset portions 28 following an essentially triangular path between center points 26.

In other embodiments, paths of cutting edge 22 betweens center points 26 and peaks 38 may vary to give the food item cut by cutting utensil 20 different shaped bite portions. The path of cutting edge 22 between center points 26 and peaks 38 may be straight, jagged, oscillatory or curved in order to produce a desirable bite portions of food items.

FIG. 2 shows a schematic front view of clean edge cutting utensil 20 according to an embodiment of the present invention including cutting edge 22 shown in FIG. 1. Clean edge cutting utensil 20 includes cutting blade 40, two handle supports 42 and a handle 44. Cutting blade 40 includes a blade body 46, cutting edge 22 and a top edge 50.

In this embodiment, blade body 46 and top edge 50 follow the same variable path as blade cutting edge 22, traversing a longitudinal plane that runs perpendicular to longitudinal axis 24 (FIG. 1), and has a wave shape when viewed from above handle 44. Thus, if viewed from above handle 44, blade 40 follows the same path shown in FIG. 1. Blade body 46 includes two outside blade offsets 25, 27, two intermediate blade offsets 31, 32 and one center blade offset 34 that follow paths of offset portions 28 of cutting edge 22. Blade side edges 129, 130 are located outside of respective outside blade offsets 25, 27. In this embodiment, blade offsets 25, 27, 31, 32, 34 are parallel to one another in a direction that is approximately perpendicular to handle 44 and an edge tip 52. Intermediate offsets 31, 32 corresponds to offset portions 28 on the second side 35 (FIG. 1) of cutting edge 22 and outside blade offsets 25, 27 and center offset blade offset 34 correspond to offset portions 28 on the first side 33 (FIG. 1) of cutting edge 22. Cutting utensil 20 is shown in FIG. 2 in an upright position, with blade 40 directly perpendicular to a cutting surface 100. It should be noted that, in many embodiments, including this embodiment, a user or an object would have to support cutting utensil 20 for cutting utensil 20 to be in this position. Blade 40 contacts cutting surface 100 at edge tip 52 at the longitudinal center of center offset blade portion 34. Edge tip 52 corresponds to peak 38 that is in the longitudinal center of cutting edge 22.

In this embodiment, cutting blade 40 is curved at cutting edge 22, such that edge tip 52 contacts cutting surface 100 when cutting utensil 20 is in the upright position, but the remainder of cutting edge 22 does not, and cutting edge 22 follows a rounded path with respect to handle 44 between cutting edge ends 30, with edge tip 52 being the peak of blade body 46. Thus, blade body 46 is a greater height at center blade offset 34 than at intermediate blade offsets 25, 27 and blade body 46 is a great height at intermediate blade offsets 31, 32 than at outside blade offsets 25, 27. When cutting utensil 20 is held in an upright position, intermediate blade offsets 31, 32 are further from cutting surface 100 than center blade offset 34, outside blade offsets 25, 27 are further from cutting surface than intermediate blade offsets 31, 32 and blade side edges 129, 130 are furthest away from cutting surface 100. Side blade edges 129, 130, may be parallel to blade offsets 25, 27, 31, 32, 34 or may be tapered towards or away from blade cutting edge 22.

In an alternative embodiment, blade body 46 may be tapered such that a top edge 50 of cutting blade 40 follows a straight path between blade side edges 129, 130. In this embodiment, top edge 50 is parallel to cutting surface 100 when blade 40 is in an upright position. In other embodiments, top edge 50 may be parallel to cutting surface 100 when blade 40 is in an upright position.

As shown in FIG. 1, blade cutting edge 22 include center points 26 where blade cutting edge 22 traverses longitudinal axis 24 and offset portions 28 between center points 26 which include peaks 38. Edge tip 52 is a point of cutting edge 22 that is furthest from top edge 50. In a preferred embodiment, edge tip 52 may be rounded and comes to a dull point, which may provide cutting stability. Edge tip 52 is approximately halfway between blade ends 29, 30 of cutting edge 22.

Handle 44, which a user grips during use of clean edge cutting utensil 20, is connected to top edge 50 of cutting blade 40 by handle supports 42. In one embodiment, handle supports 42 are long enough to allow a user's fingers to comfortably fit between handle 44 and top edge 50 of cutting blade 40. In this embodiment, handle 44 is parallel with respect to top edge 50 of blade 40. In other embodiments, handle 44 may be convex or concave with respect to blade 40 and curve away from or toward blade body 46.

In this embodiment, when clean edge cutting utensil 20 is supported in the fully upright position, only edge tip 52 of cutting blade 40 contacts cutting surface 100. In order to cut a food item, for example a sandwich or a pizza, a user of cutting utensil 20 may grab cutting utensil 20 by handle 44 and push edge tip 52 through the food item, or partially through the food item, such that edge tip 52 is supported by a normal force of the surface under the food item or the food item itself. Next, cutting utensil 20 is rocked side-to-side such that a first longitudinal side 60 of blade cutting edge 22 contacts surface 100 under the food item and then a second longitudinal side 62 of blade cutting edge 22 contacts surface 100 under the food item. Cutting utensil 20 may be rocked side-to-side in a constant path on cutting edge 22, so cutting edge 22 does not move laterally and imprecisely cut a food item.

Blade cutting edge 22 is curved in such a manner in relation to blade body 46 that blade cutting edge forms a convex shape in relation to blade body 46, with the peak of the convex shape being edge tip 52. In the fully upright position on surface 100, edge tip 52 forms angles B with blade ends 29, 30 in relation to surface 100. In a preferred embodiment, angle B is approximately five degrees for cutting stability and so blade cutting edge 22 follows the same path as cutting utensil 20 is rocked back and forth. In other embodiments, angle B may be varied to optimize cutting stability and rocking ability.

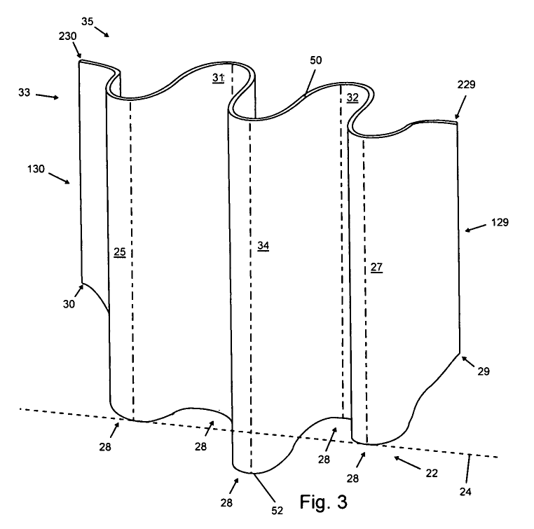

In this embodiment, handle 44 is cylindrical and a center axis of handle 44 runs parallel to top edge 50 and longitudinal axis 24 (FIGS. 1, 3). In alternative embodiments, handle may be other shapes and may even be perpendicular with respect to top edge 50.

FIG. 3 shows a perspective view of cutting blade 40 shown in FIG. 2. As cutting edge 22 approaches ends 29, 30, cutting edge 22 may be rounded to prevent sharp edges. In a preferred embodiment of the present invention, blade 40 of clean edge cutting utensil 20 does not include any sharp or pointy edges for safety purposes and to allow use of clean edge cutting utensil 20 by children. In another embodiment of the present invention, cutting edge 22 may be sharp, to allow cutting utensil 20 to cut tougher food items.

FIG. 3 mainly shows first side 33 of cutting blade 40, with second side 35 being mostly out of view. First side 33 includes three offset portions 28 and three blade offsets 25, 27, 34 and second side 35 includes two offset portions 28 and two blade offsets 31, 32. Top edge 50 of cutting blade 40 follows substantially the same path as blade cutting edge 22 such that when cutting blade 40 is in an upright position, blade offsets 25, 27, 31, 32, 34 are substantially vertical in relation to cutting edge 22.

Blade outside edges 129, 130, when cutting utensil is in an upright position, may run vertical between respective cutting edge ends 29, 30 and respective top edge ends 229, 230 or blade side edges 129, 130 may be tapered. As a user presses down on handle 44 (FIG. 2) and rocks blade cutting edge 22 back and forth along cutting edge 22 the downward force applied to handle 44 (FIG. 2) is translated through blade body 46 to blade cutting edge 22 to cut the food item underneath cutting utensil 20. The user rocks cutting utensil 20 in one direction such that blade end 30 becomes closer to the cutting surface and after blade cutting edge 22 cuts through one half of the food item being cut, cutting utensil 20 is rocked in the opposite direction about edge tip 52 so that blade end 29 becomes closer to the cutting surface so that the other half of the food item is cut. The back and forth motion may be repeated until the food item is cut.

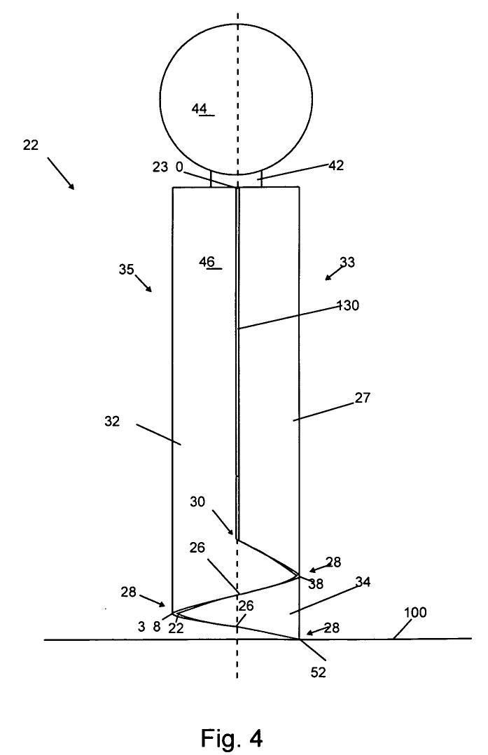

FIG. 4 shows a side view of clean edge cutting utensil 20 shown in FIG. 2. Cutting utensil 20 is shown in an upright position perpendicular to cutting surface 100 with edge tip 52 contacting cutting surface 100. Blade cutting edge 22 travels away from cutting surface 100 between edge tip 52 and cutting edge ends 29 (FIG. 2), 30 to allow cutting utensil 20 to be rocked back and forth to cut food items.

To cut a food item laying on cutting surface 100, a user may press cutting edge utensil 20, preferably edge tip 52 first, downward through the food item, such that edge tip 52 passes through the food item and contacts cutting surface 100. A user may then grip handle 44 and rock cutting utensil 20 such that one or more peaks 38 and center points 26 on of first longitudinal side 60 (FIG. 2) of blade cutting edge 22 contact cutting surface 100 and then one or more peaks 38 and center points 26 on second longitudinal side 62 (FIG. 2) of blade cutting edge contact cutting surface 100 to finish cutting the food item.

A sandwich is one example of a food item that may be cut by cutting utensil 20. To cut a sandwich the top piece of bread of the sandwich may be cut separately from the bottom piece of bread of the sandwich and the interior contents of the sandwich. Other examples of food items that may be cut by cutting utensil 20 include pizza, pancakes, quesadillas and tortillas.

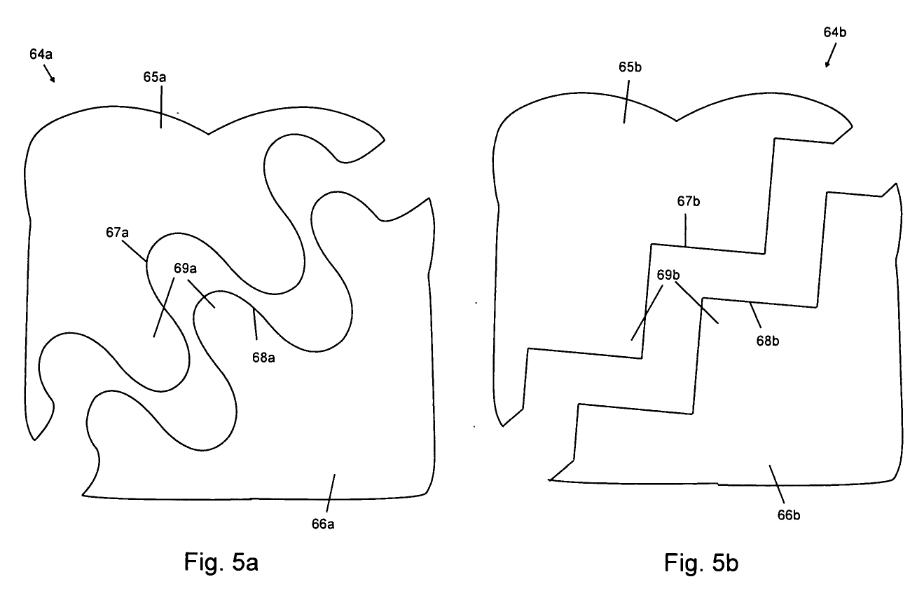

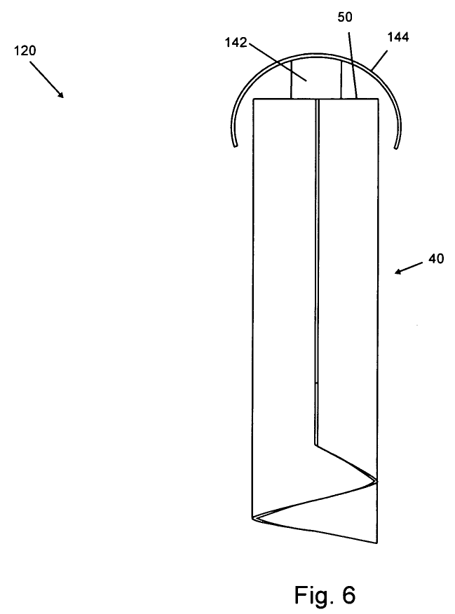

FIG. 5a shows a top view of a sandwich 64a cut by clean edge cutting utensil 20 shown in FIG. 2. Sandwich 64a has been cut into two portions 65a, 66a, each portion 65a, 66a including a respective eating edge 67a, 68a. Eating edges 67a, 68a include bite portions 69a shaped similar to offset portions 28 of blade cutting edge 22 (FIG. 1). Bite portions 69a may allow a person eating sandwich 64a to get a more substantial bite out of sandwich 64a than if sandwich 64a was cut with a conventional knife. Similarly, FIG. 5b shows a top view of a sandwich 64b cut by a cutting utensil including a cutting edge 22a as shown in FIG. 9a. Sandwich 64b has been cut into two portions 65b, 66b, each portion 65b, 66b including a respective eating edge 67b, 68b. Eating edges 67b, 68b include bite portions 69b shaped similar to offset portions 28a of blade cutting edge 22a (FIG. 9a).

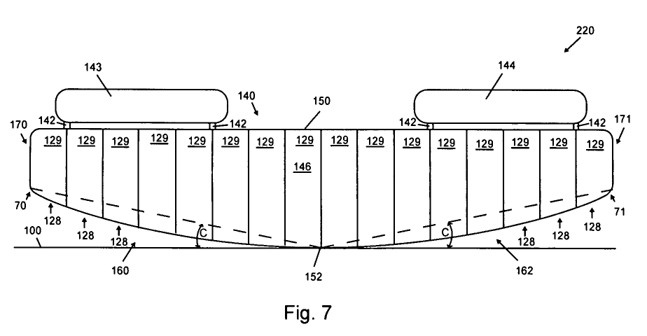

FIG. 6 shows a schematic side view of a cutting utensil 120 according to another embodiment of the present invention. Cutting utensil 120 includes blade 40 shown in FIGS. 2 to 4, but includes a handle 144 that varies from handle 44 shown in FIGS. 2 and 4. Handle 144 is connected to blade 40 via handle supports 42 but handle 144 extends in a curved path down and around top edge 50 of blade 40. In another embodiment, handle 144 may be directly connected to top edge 50.

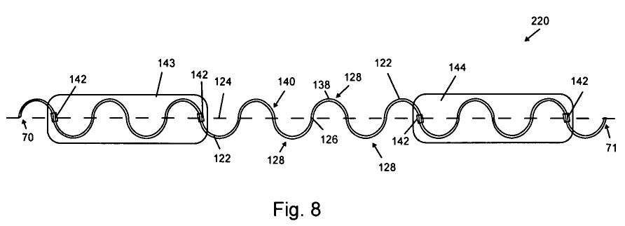

FIG. 7 shows a schematic front view of a cutting utensil 220 according to another embodiment of the present invention. In this embodiment, cutting blade 140 of cutting utensil 220 includes sixteen blade offsets 129, or bends. Blade offsets 129 may each be approximately one inch long and one inch wide with a length L of cutting blade 140 being approximately sixteen inches long. Cutting blade 140 may be a height of approximately 2.5 inches. In another embodiment of the present of cutting blade 140 may include ten blade offsets 129, with each blade offset 129 being approximately 1.6 inches long and 1.25 inches wide with length L of cutting blade 140 being approximately sixteen inches long, although dimensions may be varied based on intended use.

In this embodiment, cutting utensil 220 includes two handles 143, 144 attached to blade 140 via handle supports 142. Cutting a food item, such as a pizza, involves a user gripping both handles 144 and rocking cutting utensil 220 back and forth, pushing a first longitudinal side 160 of blade cutting edge 122 down with handle 143 and stabilizing cutting blade 122 with handle 144 while contacting and cutting through the food item and then pushing a second longitudinal side 162 of cutting edge 122 down with handle 144 and stabilizing cutting blade 140 with handle 143 while contacting and cutting through the food item.

In the fully upright position on surface 100, an edge tip 152 forms an angle C with blade ends 130 in relation to surface 100. In a preferred embodiment, angle C is approximately ten degrees for cutting stability and so blade cutting edge 122 follows the same path as cutting utensil 220 is rocked back and forth, although angle C may be varied for cutting thicker and thinner items and based on the width of offset portions 128. A longer blade 140 may need larger angles C in order to get a better rocking motion.

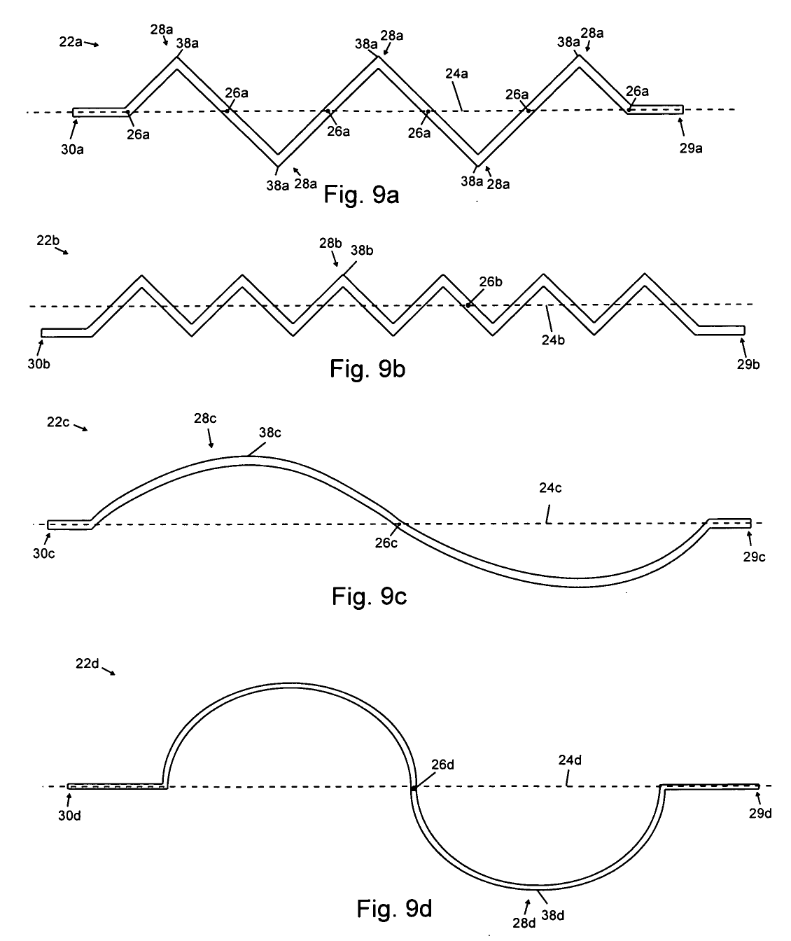

FIG. 8 shows a schematic bottom view of clean edge cutting utensil 220 shown in FIG. 7. Blade cutting edge 122 does not follow a longitudinal axis 124 of blade cutting edge 122, as does a traditional knife, but traverses longitudinal axis 124 at one or more longitudinal center points 126 in a manner similar to cutting edge 22 shown in FIG. 1. Between center points 126, offset portions 128 of blade cutting edge 122 define a variable path of blade cutting edge 122. In this embodiment, blade cutting edge 122 includes sixteen offset portions 128 which give cutting edge 122 a wave shape, with every other offset portion 128 being on an opposite side of longitudinal axis 124. Each offset portion 128 includes a peak 138, which is the point on each offset portion 128 that is furthest away from longitudinal axis 124. Blade cutting edge 122 forms a continuous path between blade ends 70, 71.

In this embodiment, each offset portion 128 follows a rounded path at each peak 138 and cutting edge 122 follows an oscillatory path between center points 126. Peaks 138 may be closer and further away from longitudinal 124 axis depending on the desired variability of the food item bite edge. Cutting blade 140 may be connected to handles 143, 144 via handle supports 142 near longitudinal axis 124.

Blades 40 and 140 may be made of plastic or metal and may be formed by conventional techniques such as die-casting or molding, for example. In one preferred embodiment, a cutting blade is a piece of sheet metal and the piece of sheet metal is bent by a forming machine to form the longitudinal offset portions and the blade offsets.

Handle as used herein is defined as any surface of the cutting utensil that may be gripped to rock the cutting blade back and forth about the edge tip.

FIGS. 9a to 9g show different shaped cutting edges 22a, 22b, 22c, 22d, 22e, 22f, 22g which may be including in different cutting utensils according to further embodiments of the present invention. Edge cutting edge 22a, 22b, 22c, 22d, 22e, 22f, 22g includes respective offset portions 28a, 28b, 28c, 28d, 28e, 28f, 28g, each having a respective peak 38a, 38b, 38c, 38d, 38e, 38f, 38g. Cutting edges 22a, 22b, 22c, 22d, 22e, 22f, 22g traverse respective longitudinal axes 24a, 24b, 24c, 24d, 24e, 24f at respective center points 26a, 26b, 26c, 26d, 26e, 26f, 26g between respective first end 29a, 29b, 29c, 29d, 29e, 29f, 29g and respective second end 30a, 30b, 30c, 30d, 30e, 30f, 30g.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A cutting utensil for cutting food items resting on a cutting surface comprising:
a cutting blade including a blade cutting edge having a longitudinal axis, the cutting blade including a plurality of offset portions that are offset from longitudinal axis, the cutting blade further including an edge tip for contacting the food item, the edge tip adapted to allow cutting blade to be rocked back and forth about the blade cutting edge; and
a handle connected to the cutting blade that is capable of being gripped by a user and used to rock the cutting blade back and forth about the blade cutting edge on the cutting surface.

2. The cutting utensil recited in claim 1 wherein the blade cutting edge includes center points along the longitudinal axis defining edges of the offset portions, the blade cutting edge traversing the longitudinal axis at the center points.

3. The cutting utensil recited in claim 1 wherein the cutting blade includes a blade body and a top edge, the blade body being located between the cutting edge and the top edge and the handle being connected to the top edge.

4. The cutting utensil recited in claim 3 wherein the blade body includes blade offsets following the path of the offset portions of the blade cutting edge.

5. The cutting utensil recited in claim 4 wherein some of the blade body offsets are on a first side of the cutting blade and some of the blade body offsets are on a second side of the cutting blade.

6. The cutting utensil recited in claim 3 wherein the cutting edge includes cutting ends and the cutting edge follows a rounded path with respect to the blade body between the cutting ends with the edge tip being a peak of the rounded path.

7. The cutting utensil recited in claim 3 wherein the blade body includes a longitudinal center and two blade side edges, the blade body being greater in height in the longitudinal center than at the blade side edges.

8. The cutting utensil recited in claim 1 wherein the blade cutting edge is continuous between a first cutting edge end and a second cutting edge end, the blade cutting edge including a first longitudinal portion between the first cutting edge end and the edge tip and a second longitudinal portion between the second end and the edge tip.

9. The cutting utensil recited in claim 8 wherein the cutting blade is adapted for cutting the food item by rocking the cutting blade about the first tip such that the first longitudinal portion of blade cutting edge contacts the food item and then the second longitudinal portion of the blade cutting edge contacts the food item to cut the food item.

10. The cutting utensil recited in claim 1 further comprising handle supports connecting the cutting blade to the handle.

11. The cutting utensil recited in claim 1 wherein the cutting blade is made of sheet metal and the offset portions are bends in the sheet metal.

12. A method of cutting a food item positioned on a cutting surface comprising
providing a cutting blade including a blade cutting edge, the blade cutting edge traversing a longitudinal axis of the blade cutting edge to form offset portions, the blade cutting edge including an edge tip near or on a longitudinal center of the blade cutting edge;
placing a food item on the cutting surface;
contacting the food item with the blade cutting edge; and
rocking the cutting blade back and forth about the blade cutting edge to cut the food item.

13. The method as recited in claim 12 wherein the wherein the cutting blade includes a first longitudinal portion and a second longitudinal portion and the rocking step includes rocking the cutting blade about the first tip such that the first longitudinal portion of blade cutting edge contacts the food item and then rocking the second longitudinal portion of the blade cutting edge contacts the food item to cut the food item

14. The method as recited in claim 13 wherein cutting blade includes a first longitudinal end and a second longitudinal end and the cutting blade is greater in height at the longitudinal center than at the first and second longitudinal ends so that the blade cutting edge is curved and as the cutting blade is rocked back and forth about the blade cutting edge the first longitudinal end moves closer to the cutting surface and then the second longitudinal end moves closer to the cutting surface.
